(19) United States
(12) Patent Application Publication
(10) Pub. No.: US 2025/0338162 A1
(43) Pub. Date: Oct. 30, 2025

(54) DEVICES FOR PERFORMING WIRELESS SENSING AND METHODS OF OPERATING THE SAME

(71) Applicant: HUAWEI TECHNOLOGIES CO., LTD., Shenzhen (CN)

(72) Inventors: Mario Hernán CASTAÑEDA GARCIA, Munich (DE); Richard STIRLING-GALLACHER, Munich (DE); Anastasios KAKKAVAS, Munich (DE); Xitao GONG, Munich (DE)

(73) Assignee: HUAWEI TECHNOLOGIES CO., LTD., Shenzhen (CN)

(21) Appl. No.: 19/263,817

(22) Filed: Jul. 9, 2025

Related U.S. Application Data
(63) Continuation of application No. PCT/EP2023/050375, filed on Jan. 10, 2023.

(51) Int. Cl. H04W 24/10; H04B 17/318

(52) U.S. Cl. CPC H04W 24/10; H04B 17/328

(57) ABSTRACT

First and second devices for wireless sensing are provided. The first device receives, from the second device, which is in communication with the first device, a configuration for identifying a set of transmit resources of the second device that are associated with a non-line-of-sight (NLOS) link between the first device and the second device. The first device receives a signal of one or more transmit resources of the second device and identifies the one or more transmit resources of the second device, in accordance with the configuration. This limits a measurement reporting quantity and ensures a quality of the measurement reporting in connection with a multistatic sensing procedure.

### CROSS REFERENCE TO RELATED APPLICATION

This application is a continuation of International Application No. PCT/EP2023/050375, filed on Jan. 10, 2023, the disclosure of which is hereby incorporated by reference in its entirety.

### TECHNICAL FIELD

The present disclosure relates generally to the field of mobile communications, and more specifically to devices for performing wireless sensing and to methods of operating such devices.

### BACKGROUND ART

Current communications systems, like 3rd generation partnership project (3GPP) Long Term Evolution (LTE) and New Radio (NR), support the localization of active devices, i.e. devices that are involved in the transmission (Tx) or reception (Rx) of the signal used for localization. However, it is envisioned that the functionality of sensing passive objects, i.e. objects that do not participate in the Tx/Rx of the signal used for sensing, will be integrated with the communication functionality of upcoming communication systems, e.g. 5G Advanced or 6G. As used herein, sensing may refer not only to the estimation of the position of an object, but also to its detection, as well as its shape and even its composition.

From a transceiver deployment point of view, two different sensing approaches exist. Monostatic sensing involves a co-location of a sensing transmitter and receiver, and the device may sense its environment. Full-duplex operation is required in this case. Multistatic sensing relates to the sensing transmitter and receiver being at different locations and network-related operations being required for the sensing measurements. FIG. 1 illustrates an exemplary multistatic sensing scenario. Multi-static sensing allows an object to be viewed from different angular perspectives, which can be beneficial for optimal passive object recognition and localization. As this approach does not require full-duplex operation and can re-use existing communication waveforms, e.g., orthogonal frequency division multiplexing (OFDM) and discrete Fourier transform-spread-OFDM (DFT-s-OFDM), it can be more easily integrated into the current specification. In connection with multi-static sensing, several issues may arise.

First, beam management procedures for communication are not appropriate for multistatic sensing as their measurement report is tailored for identifying the strongest paths, and not for identifying particular reflections. However, requiring each Tx device to sweep its Tx beams and each Rx device to also sweep its Rx beams may lead to activating more devices and Tx/Rx resources (beams) than actually needed, which is inefficient and increases overhead and latency.

Second, a higher sensing resolution may require a large bandwidth, which is available at higher frequencies, i.e., at mmWave and sub-THz bands. Accordingly, beamforming may be needed to support wideband sensing. More specifically, a Tx device may send a sensing signal with a certain Tx beam towards a passive object while an Rx device may receive a reflection for the passive object with a certain Rx beam. In particular, each Tx device needs to know in which direction to transmit beamformed signals towards a passive object, which can then be received by other devices. In addition, each Rx device needs to adapt its receive beamforming depending on the passive object and transmitted beamformed signal.

### SUMMARY

It is an object to overcome the above-mentioned and other drawbacks. The foregoing and other objects are achieved by the features of the independent claims. Further implementation forms are apparent from the dependent claims, the description, and the figures.

According to a first aspect, a first device for performing wireless sensing is provided. The first device is configured to send, to one or more second devices connected with the first device, a configuration for identifying a set of transmit resources of the first device being associated with a non-line-of-sight, NLOS, link between the first device and the respective one or more second devices; send a signal via one or more transmit resources of the first device;

and receive, from the one or more second devices, respective measurement reports being indicative of the set of transmit resources of the first device.

A configuration supporting the identification of transmit resources associated with strong enough NLOS links allows for identifying devices and beam directions for sensing a passive object.

This limits a quantity of, and ensures a quality of, the measurement reporting in connection with the sensing procedure, thereby improving efficiency and decreasing both overhead and latency. Additionally, a coordination of the Tx and Rx beams is achieved.

A first device and a second device, as used herein, may respectively refer to a stationary or a mobile endpoint of a radio access technology (RAT) such as NR (5G New Radio) or LTE (4G Long Term Evolution) of a mobile communication system. Exemplary stationary endpoints include a base station, such as a gNB (5G base station) or an eNB (4G base station), a transmit/receive point (TRP or TRxP) such as a stationary antenna array (i.e., array of antenna elements) of the mobile communication system, a road side unit (RSU), or the like. Exemplary mobile endpoints include user equipment (UE) such as mobile phones, handheld devices, devices on a vehicle, devices on a robot, or the like.

Wireless sensing, as used herein, may refer to a detection of a passive object, and to an estimation of a position, a shape and even a composition of the passive object.

A position or spatial position, as used herein, may refer to an indication of a geographic location as specified by a two-dimensional or three-dimensional geographic coordinate. For example, a particular position may include latitude and longitude components and optionally an altitude/height component relative to a given coordinate reference system. In particular, the position may be associated with the moment of the measurement or reception of the signal of the one or more transmit resources.

A configuration, as used herein, may refer to parameter information for a device in order to perform wireless sensing.

A transmit (Tx) resource, as used herein, may refer to a radio resource being defined in terms of one or more of a time, a frequency, and a spatial filter. A spatial filter or beam, as used herein, may interchangeably refer to a result of spatial filtering or beamforming, i.e., a signal processing technique used for directional signal transmission or reception (spatial directivity/selectivity), by combining elements in an antenna array in such a way that the resulting radio signal experiences constructive addition at particular angles while experiencing lower gain at other angles.

A signal or radio signal as used herein may refer to a sensing signal, an illumination signal, a reference signal (e.g., a positioning reference signal), a control signal, or a communication signal (e.g., a signal carrying a data transmission), for example. In addition, the signal sent on one transmit resource can be different from a signal sent on another transmit resource.

According to a second aspect, a second device for wireless sensing is provided. The second device is configured to receive, from a first device connected with the second device, a configuration for identifying a set of transmit resources of the first device being associated with a non-line-of-sight, NLOS, link between the first device and the second device; receive a signal of one or more transmit resources of the first device; identify a set of the one or more transmit resources of the first device being associated with an NLOS link between the first device and the second device, in accordance with the configuration; and send, to the first device, a measurement report being indicative of the set of transmit resources of the first device.

In some embodiments, for receiving the signal, the second device may further be configured to determine a reception level of the signal of the one or more transmit resources of the first device.

A reception level, as used herein, may refer to a relative strength of a received (Rx) radio signal with respect to a given absolute/reference strength. For example, a reception level specified in ‘dBm’ implies an absolute/reference strength of 1 mW. A reception level may refer to a reference signal received power (RSRP).

In some embodiments, for identifying the set of the one or more transmit resources, the second device may further be configured to determine a largest reception level among the determined reception levels.

In some embodiments, for identifying the set of the one or more transmit resources, the second device may further be configured to determine an LOS/NLOS indicator for the signal of the one or more transmit resources of the first device.

A line-of-sight (LOS)/non-line-of-sight (NLOS) indicator, as used herein, may refer to a soft value or probability, specified as a percentage, whether a transmitted or received signal is associated with a LOS link and not associated with an NLOS link, and vice versa. Depending on a definition of the LOS/NLOS indicator, its value may indicate a low probability (e.g., 10%) of a LOS link and at the same time a high probability (e.g., 90%) of an NLOS link, for example. In particular, the LOS/NLOS indicator may be determined for a measurement of the signal of the one or more transmit resources, or may be provided to the second device by the first device. For example, the LOS/NLOS indicator may be defined per transmit-receive point (TRP), e.g., gNB. For example, the LOS/NLOS indicator may be defined also per a reference signal. The LOS/NLOS indicator may also refer to a hard value, i.e., 0 or 1.

A LOS link, as used herein, may refer to a circumstance wherein a radio signal propagates in a straight line from a transmitter to a receiver, whereas an NLOS link, as used herein, may refer to a circumstance wherein a radio signal does not propagate in a straight line from a transmitter to a receiver. For example, a LOS link can be determined based on a distribution of a reception level or based on a largest reception level (e.g., if it is above a threshold).

In some embodiments, for identifying the set of the one or more transmit resources, the second device may further be configured to determine an availability of a LOS link between the first device and the second device in accordance with one or more of: the determined reception level of the signal of the one or more transmit resources of the first device, the determined LOS/NLOS indicators for the signal of the one or more transmit resources of the first device, and a LOS/NLOS indicator associated with the first device and the second device being obtainable at the second device.

In some embodiments, for determining the availability of a LOS link between the first device and the second device, the second device may further be configured to determine a largest LOS/NLOS indicator among the determined LOS/NLOS indicators for the signal of the one or more transmit resources of the first device; and determine the availability of a LOS link between the first device and the second device if the largest LOS/NLOS indicator is equal to or above a lower bound for a LOS link.

In some embodiments, for identifying the set of the one or more transmit resources, the second device may further be configured, upon an availability of a LOS link between the first device and the second device, to identify the set of the one or more transmit resources to be associated with an NLOS link between the first device and the second device upon one or more of: if the determined reception level of the signal of the one or more transmit resources of the first device falls within a range defined by a first upper bound and a first lower bound for the reception level; and if the determined LOS/NLOS indicator for the signal of the one or more transmit resources of the first device is equal to or below a first upper bound for the LOS/NLOS indicator.

A reporting of transmit resources with RSRP<threshold depending on LOS path RSRP (i.e. relative threshold) avoids reporting transmit resources associated with a LOS path.

A reporting of transmit resources with LOS/NLOS indicator<threshold depending on LOS path indicator (i.e. relative threshold) avoids reporting transmit resources associated with LOS path.

In some embodiments, for identifying the set of the one or more transmit resources, the second device may further be configured, upon a non-availability of a LOS link between the first device and the second device, to identify the set of the one or more transmit resources to be associated with an NLOS link between the first device and the second device if the determined reception level of the signal of the one or more transmit resources of the first device is equal to or above a second lower bound for the reception level.

A reporting of transmit resources with RSRP equal to or above a threshold depending on a strongest RSRP of a NLOS path (i.e. relative threshold) avoids reporting transmit resources being associated with weak NLOS reflections, and supports identifying transmit resources with a strong enough NLOS path, independent of the distance between the first and second device.

In some embodiments, for identifying the set of the one or more transmit resources, the second device may further be configured, upon an availability of a LOS link between the first device and the second device and if the largest reception level and the largest LOS/NLOS indicator relate to different transmit resources of the first device, to identify the set of the one or more transmit resources to be associated with an NLOS link between the first device and the second device upon one or more of: if the determined reception level of the signal of the one or more transmit resources of the first device is equal to or above a third lower bound for the reception level; and if the determined LOS/NLOS indicator for the signal of the one or more transmit resources of the first device is equal to or below a third upper bound for the LOS/NLOS indicator.

In some embodiments, for sending the measurement report, the second device may further be configured to select up to a configured maximum number of the identified set of the one or more transmit resources of the first device being associated with a respective NLOS link between the first device and the second device, in accordance with the configuration.

In some embodiments, the configuration may comprise the lower bound for a LOS link.

In some embodiments, the configuration may comprise an offset of the second lower bound for the reception level of the respective second device for the NLOS link between the first device and the respective second device relative to the largest reception level.

In some embodiments, the configuration may comprise a lower bound for the second lower bound for the reception level of the respective second device for the NLOS link between the first device and the respective second device.

In some embodiments, the configuration may comprise an offset of the first lower bound for the reception level of the respective second device for the NLOS link between the first device and the respective second device relative to the largest reception level.

In some embodiments, the configuration may comprise a lower bound for the first lower bound for the reception level of the respective second device for the NLOS link between the first device and the respective second device.

In some embodiments, the configuration may comprise an offset of the first upper bound for the reception level of the respective second device for the NLOS link between the first device and the respective second device relative to the largest reception level.

In some embodiments, the configuration may comprise an offset of the first upper bound for the LOS/NLOS indicator.

In some embodiments, the configuration may comprise an offset of the third lower bound for the reception level of the respective second device for the NLOS link between the first device and the respective second device relative to the largest reception level.

In some embodiments, the configuration may comprise a lower bound for the third lower bound for the reception level of the respective second device for the NLOS link between the first device and the respective second device.

In some embodiments, the measurement report may comprise the determined reception levels of the signal being received by the second device via the selected set of transmit resources of the first device.

In some embodiments, the measurement report may comprise identifiers of the selected set of transmit resources of the first device.

In some embodiments, the measurement report may comprise the largest LOS/NLOS indicator; and an identifier of the transmit resource of the first device relating to the same.

In some embodiments, the measurement report may comprise one or more of: a position of the second device, and an orientation of the second device.

A reporting of a device position when there are no identified transmit resources indicates that the position is not relevant for sensing, and when transmit resources are identified, the reported position is of interest for sensing.

An orientation or spatial orientation, as used herein, may refer to an indication of a direction relative to the given coordinate reference system.

According to a third aspect, a method of operating a first device for performing wireless sensing is provided. The method comprises sending, to one or more second devices connected with the first device, a configuration for identifying a set of transmit resources of the first device being associated with a non-line-of-sight, NLOS, link between the first device and the respective second device; sending a signal via one or more transmit resources of the first device; and receiving, from the one or more second devices, respective measurement reports being indicative of the set of transmit resources of the first device.

In some embodiments, the method may be performed by the first device of the first aspect or any of its implementations.

According to a fourth aspect, a method of operating a second device for performing wireless sensing is provided. The method comprises receiving, from a first device connected with the second device, a configuration for identifying a set of transmit resources of the first device being associated with a non-line-of-sight, NLOS, link between the first device and the second device; receiving a signal of one or more transmit resources of the first device; identifying a set of the one or more transmit resources of the first device being associated with an NLOS link between the first device and the second device, in accordance with the configuration; and sending, to the first device, a measurement report being indicative of the set of transmit resources of the first device.

In some embodiments, the method may be performed by the second device of the second aspect or any of its implementations.

According to a fifth aspect, a computer program is provided. The computer program comprises a program code for performing the method of the first aspect or any of its implementations or the method of the second aspect or any of its implementations, when executed on a computer.

### BRIEF DESCRIPTION OF DRAWINGS

The above-described aspects and implementations will now be explained with reference to the accompanying drawings, in which the same or similar reference numerals designate the same or similar elements.

The drawings are to be regarded as being schematic representations, and elements illustrated in the drawings are not necessarily shown to scale. Rather, the various elements are represented such that their function and general purpose become apparent to those skilled in the art.

FIG. 1 illustrates an exemplary multistatic sensing scenario in accordance with the present disclosure;

FIG. 2 illustrates an interaction between a first device and a second device in accordance with the present disclosure;

FIG. 3 illustrates further implementation forms of the second device in accordance with the present disclosure; and

FIGS. 4 and 5 illustrate different phases of wireless sensing in accordance with the present disclosure.

### DETAILED DESCRIPTIONS OF DRAWINGS

In the following description, reference is made to the accompanying drawings, which form part of the disclosure, and which show, by way of illustration, specific aspects of implementations of the present disclosure or specific aspects in which implementations of the present disclosure may be used. It is understood that implementations of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding apparatus or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary implementations and/or aspects described herein may be combined with each other, unless specifically noted otherwise. The term “unit,” as used herein, may refer to hardware, software, or hardware configured with software.

Multi-static sensing, with UEs acting as transmitters and/or receivers, is expected to be used in many of the envisioned sensing use cases to be realized in 3GPP 5G-Advanced and 6G systems, due to its compatibility with, and, hence, its ease of integration to the current mobile communication systems' architecture. Example use cases include environment mapping, vulnerable road user protection, intruder detection, remote health monitoring (e.g. respiration/heart rate measurement, fall detection), etc. Taking the intruder detection use case as an example, beams used in mobile communications may be steered in the direction of possible intrusion points to detect any change in a probe signal due to a presence of an intruder and trigger an alarm.

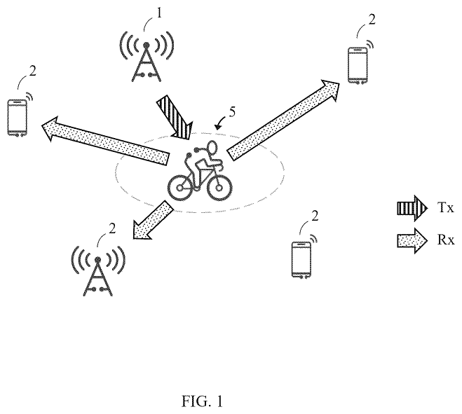

FIG. 1 illustrates an exemplary multistatic sensing scenario in accordance with the present disclosure.

Depicted is a non-limiting exemplary system 1, 2 comprising a first device 1 according to the first aspect of the present disclosure and five (i.e., two or more) second devices 2 according to the second aspect.

In this particular example, the first device 1 comprises a BS in DL transmission, and the respective second device 2 comprises a UE in DL reception or a BS in UL reception, respectively, in accordance with the intended multistatic sensing.

The first device 1 may be configured to illuminate a target area 5, where a presence of a passive object may be suspected, by transmitting a beamformed signal in its direction. The second devices 2 may be configured to receive the beamformed signal being reflected/deflected towards their respective position. Note that this does not necessarily mean that every second device 2 receives at least some of the beamformed signal. In the example of FIG. 1, one of the second devices 2 is shown as not receiving any reflection/deflection at all.

The respective positions of the second devices 2 are assumed to be known by the first device 1.

In the following, the present disclosure particularly deals with
the selection of the second devices 2 participating in the sensing, and
the selection of the beams of the first device 1 and the selected second devices 2.

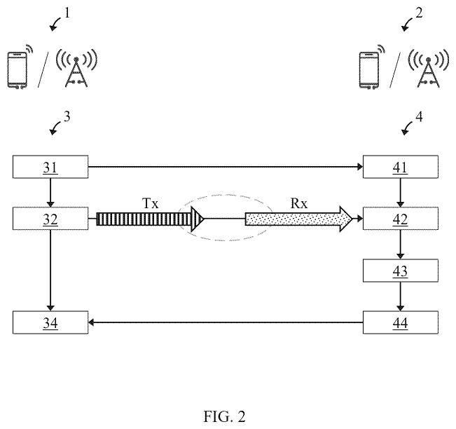

FIG. 2 illustrates an interaction between a first device 1 and a second device 2 in accordance with the present disclosure.

The first device 1 depicted on the left of FIG. 2 is suitable for performing wireless sensing by performing the method 3 of the third aspect.

The first device 1 is configured to send 31, to one or more second devices 2 connected with the first device 1, a configuration for identifying a set of transmit resources of the first device 1 being associated with an NLOS link between the first device 1 and the respective second device 2.

Despite FIG. 2 featuring only one second device 2 for improved clarity, more than one second device 2 may be involved in a typical multistatic sensing scenario as exemplified in FIG. 1.

The second device 2 shown on the right of FIG. 2 is also suitable for performing wireless sensing for its part by performing the method 4 of the fourth aspect. Corresponding to the first device 1, the second device 2 is configured to receive 41, from the first device 1 connected with the second device 2, the configuration for identifying the set of the transmit resources of the first device 1 being associated with a non-line-of-sight, NLOS, link between the first device 1 and the second device 2.

Accordingly, the method steps 31 and 41 initiate a sensing procedure by setting up the devices and beams to be used for sensing.

That is to say, a first device 1 configures second devices 2 to make measurements of a sensing signal. The sensing signal can be sent by the first device 1 or by a third device (not shown). For simplicity it is assumed in the following that the sensing signal is sent by the first device 1.

More specifically, the first device 1 configures the second devices 2 to listen to a set of N transmit resources sent by the first device 1, to measure the RSRP and the LOS/NLOS indicator of each of the N transmit resources (i.e., the first device 1 indicates the time and frequency of the N transmit resources), and to report strong reception levels of these transmit resources which are not associated with a respective LOS link. This can be achieved based on some thresholds on the reception level which depend on whether the link between the first device 1 and the respective second device 2 is a LOS link or not. The key point is to identify “strong enough” NLOS links/paths, i.e. involving a deflection/reflection. To identify such NLOS links, the second devices 2 can also report LOS/NLOS indicators for these transmit resources. For this purpose, some thresholds can be considered as well.

The configuration may comprise a lower bound I_{Δ,1} for a LOS link, or more specifically, a lower bound I_{Δ,1} for a LOS/NLOS indicator I being indicative of a LOS link.

The configuration may further comprise an offset RSRP_{Δ,3} of a second lower bound max(RSRPₘₐₓ−RSRP_{Δ,3}, RSRP_{min,2}) for a reception level RSRP of the respective second device 2 for a NLOS link between the first device 1 and the respective second device 2 relative to the largest reception level RSRPₘₐₓ.

The configuration may further comprise a lower bound RSRP_{min,2} for the second lower bound max(RSRPₘₐₓ−RSRP_{Δ,3}, RSRP_{min,2}) for the reception level RSRP of the respective second device 2 for the NLOS link between the first device 1 and the respective second device 2.

The configuration may further comprise an offset RSRP_{Δ,1} of a first lower bound max(RSRPₘₐₓ−RSRP_{Δ,1}, RSRP_{min,1}) for the reception level RSRP of the respective second device 2 for the NLOS link between the first device 1 and the respective second device 2 relative to the largest reception level RSRPₘₐₓ.

The configuration may further comprise a lower bound RSRP_{min,1} for the first lower bound max(RSRPₘₐₓ−RSRP_{Δ,1}, RSRP_{min,1}) for the reception level RSRP of the respective second device 2 for the NLOS link between the first device 1 and the respective second device 2.

The configuration may further comprise an offset RSRP_{Δ,2} of the first upper bound RSRPₘₐₓ−RSRP_{Δ,2} for the reception level RSRP of the respective second device 2 for the NLOS link between the first device 1 and the respective second device 2 relative to the largest reception level RSRPₘₐₓ.

The configuration may further comprise an offset I_{Δ,2} of a first upper bound Iₘₐₓ−I_{Δ,2} for the LOS/NLOS indicator I.

The configuration may further comprise an offset RSRP_{Δ,4} of a third lower bound max(RSRPₘₐₓ−RSRP_{Δ,4}, RSRP_{min,3}) for the reception level RSRP of the respective second device 2 for the NLOS link between the first device 1 and the respective second device 2 relative to the largest reception level RSRPₘₐₓ.

The configuration may further comprise a lower bound RSRP_{min,3} for the third lower bound max(RSRPₘₐₓ−RSRP_{Δ,4}, RSRP_{min,3}) for the reception level RSRP of the respective second device 2 for the NLOS link between the first device 1 and the respective second device 2.

Any bound or offset not forming part of this configuration should be preconfigured within the respective second device 2.

The first device 1 is further configured to send 32 a signal via one or more transmit resources i of the first device 1. In other words, the first device 1 may send sensing signals with N transmit resources (i.e. Tx beams). For example, a different sensing signal may be used per transmit resource, or a same sensing signal may be used for all transmit resources, or any solution in between.

Correspondingly, the second device 2 is further configured to receive 42 the signal of one or more transmit resources i of the first device 1. This may include making measurements of the one or more transmit resources i.

Thus, method steps 32 and 42 start the sensing procedure, e.g., by illuminating a target area 5. This may involve an initial stage sensing with one signal and further refined sensing with another signal, for example.

The second device 2 is further configured to identify 43 a set of the one or more transmit resources i of the first device 1 being associated with an NLOS link between the first device 1 and the second device 2, in accordance with the configuration.

The second device 2 is further configured to send 44, to the first device 1, a measurement report being indicative of the set of transmit resources of the first device 1.

Correspondingly, the first device 1 is further configured to receive 34, from the one or more second devices 2, respective measurement reports being indicative of the set of transmit resources of the first device 1.

Hence, the method steps 43-44 and 34 complete the sensing procedure by processing of measurements, i.e., for object recognition, localization, tracking, etc.

The above workflows correspond to a method 3 of operating the first device 1 and to a method 4 of operating the second device 2. The method 3 of operating the first device 1 may be performed by the first device 1, whereas the method 4 of operating the second device 2 may be performed by the second device 2.

The measurement report may comprise the determined reception levels RSRPᵢ of the signal being received by the second device 2 via the selected set of transmit resources of the first device 1.

The measurement report may comprise identifiers of the selected set of transmit resources of the first device 1.

The measurement report may comprise the largest LOS/NLOS indicator Iₘₐₓ; and an identifier of the transmit resource of the first device 1 relating to the same.

The measurement report may comprise one or more of: a position of the second device 2 (i.e., where it made a measurement), and an orientation of the second device 2. Such feedback may even be made in situations where the second device 2 does not identify any transmit resources.

The measurement report may further comprise a time stamp when the measurements were made, which may particularly be important in situations where second devices 2 are in motion. Such enhancement to the measurement report enables an identification of good and bad device positions for multi-static sensing. This is of particular interest in the case where a second device 2 is configured with precise positioning and which can be configured to go to a certain position, e.g. for robot UEs (see below).

The measurement report may thus include measurements associated with the identified reflections, e.g., RSRP, delay, and/or LOS/NLOS indicator of a transmit resource and an identifier of the associated transmit resource of a measurement. Based on the proposed measurement report sent to the first device 1 from the second devices 2, the first device 1 knows which second devices 2 can receive a transmit resource (from the first device 1) via potential passive objects, as well as which transmit resources (=Tx beam directions) these correspond to. Based on the above information, the first device 1 can perform a selection of second devices 2, i.e. it knows which transmit resources can be received by which second devices 2.

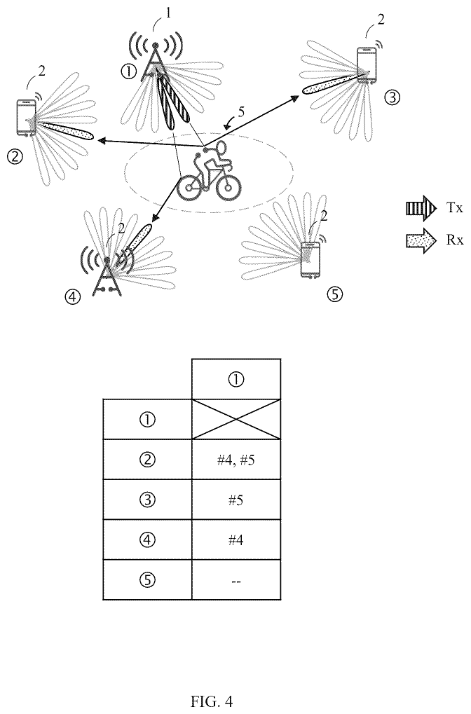

In the sensing scenario of FIG. 4, the first device 1 identified as \textcircled{1} learns that the second device 2 identified as \textcircled{2} can receive its transmit resources #4 and #5 via a strong enough reflection, the second device 2 identified as \textcircled{3} can receive its transmit resource #5 via a strong enough reflection, the second device 2 identified as \textcircled{4} can receive its transmit resource #4 via a strong enough reflection, and the second device 2 identified as \textcircled{5} does not receive a strong enough deflection/reflection.

Afterwards, the first device 1 may configure the selected second devices 2 to act as first devices 1 so as to transmit beamformed signals based on beam correspondence of the identified transmit resources, i.e. transmit via the NLOS link deflected/reflected by the passive object. Beam correspondence refers to using for a transmission the same beam (spatial filter) used for receiving a given signal. The selected second devices 2 can be configured to transmit a signal at different times, allowing the second devices 2 to listen for the signal among the others. The selected second devices 2 can also be configured to transmit a signal using different time-frequency resources. For this second round of transmission of sensing signals and measurements, the first device 1 may configure the other second devices 2 to listen and make measurements as proposed before (e.g., to identify strongest NLOS reception levels) and to send back to the first device 1 the measurements associated with the identified reflections.

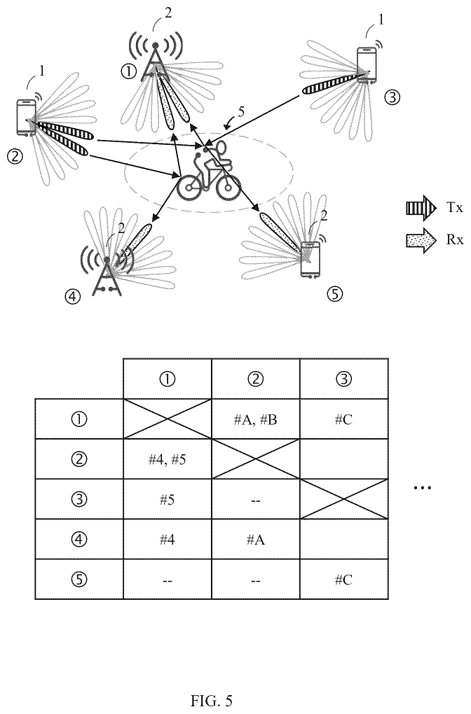

In the sensing scenario of FIG. 5, the first device 1 identified as \textcircled{2} learns that the second device 2 identified as \textcircled{1} can receive its transmit resources #A and #B via a strong enough reflection, and the second device 2 identified as \textcircled{4} can receive its transmit resource #A via a strong enough reflection, and the second device 2 identified as \textcircled{3} learns that the second devices 2 identified as \textcircled{1} and \textcircled{5} can receive its transmit resource #C via a strong enough reflection.

Thus, based on measurements of previous steps, in successive steps only certain first devices 1 can transmit based on certain transmit resources (reducing overhead and latency). Note that adjacent Tx beams of identified transmit resources can also be activated for the sensing (i.e., based on a certain angular range).

The proposed scheme can be extended not only to consider device selection, but also for selection of device positions. In particular, for this setup robotic UEs are considered. A robot UE can have accurate positioning and can be configured to move to indicated positions or along a certain path. A robot UE can be exploited to identify device positions which are of interest for multi-static sensing in a given environment.

In more detail, the robot UE acting as a second device 2 may move on a given path (e.g., determined by the robot) and perform the above-described measurement reporting as a first device 1 sweeps its Tx beams, e.g. periodically transmits on different beams a sensing signal. The measurement reporting may be enhanced by configuring the robot UE to feed back its position along with measurements of an identified reflection, and/or to indicate as well its positions where it did not identify any transmit resources that can be associated with a reflection, i.e., where it did not identify a strong enough NLOS link. Based on the enhanced measurement report, the reported device positions can be taken into consideration for multi-static sensing with multiple devices later on. Thus, it would be known where to place robot UEs for further sensing of an identified passive object, and where not to place robot UEs as no reflections can be identified there.

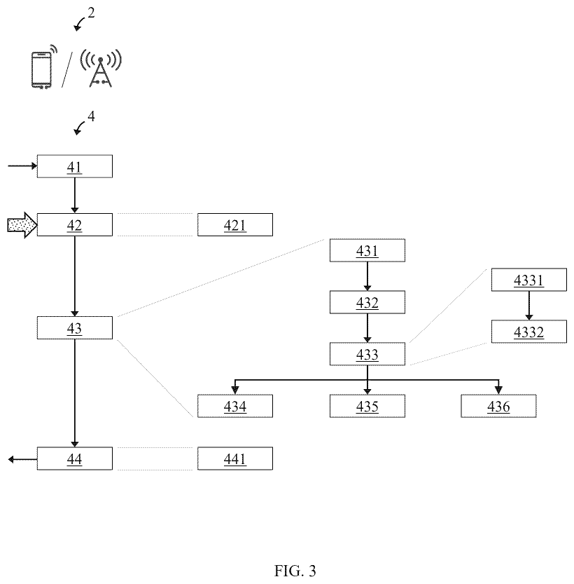

FIG. 3 illustrates further embodiments of the second device 2 in accordance with the present disclosure.

For receiving 42 the signal, the second device 2 may further be configured to determine 421 a reception level RSRPᵢ of the signal of the one or more transmit resources i of the first device 1.

For identifying 43 the set of the one or more transmit resources i, the second device 2 may further be configured to determine 431 a largest reception level RSRPₘₐₓ among the determined reception levels RSRPᵢ:

$${PSPR}_{max} = {max}_{i} ( {RSRP}_{i} )$$

For identifying 43 the set of the one or more transmit resources i, the second device 2 may further be configured to determine 432 an LOS/NLOS indicator Iᵢ for the signal of the one or more transmit resources i of the first device 1.

For identifying 43 the set of the one or more transmit resources i, the second device 2 may further be configured to determine 433 an availability of a LOS link between the first device 1 and the second device 2 in accordance with one or more of: the determined reception levels RSRPᵢ of the signal of the one or more transmit resources i of the first device 1, the determined LOS/NLOS indicators Iᵢ for the signal of the one or more transmit resources i of the first device 1, and an LOS/NLOS indicator associated with the first device 1 and the second device 2 being obtainable at the second device 2.

For determining 433 the availability of a LOS link between the first device 1 and the second device 2, the second device 2 may further be configured to determine 4331 a largest LOS/NLOS indicator Iₘₐₓ among the determined LOS/NLOS indicators Iᵢ for the signal of the one or more transmit resources i of the first device 1; and determine 4332 the availability of a LOS link between the first device 1 and the second device 2 if the largest LOS/NLOS indicator Iₘₐₓ is equal to or above a lower bound I_{Δ,1} for a LOS link:

$${I}_{max} = {max}_{i} ( {I}_{i} )$$

$${I}_{max} = \{ \begin{matrix}\geq {I}_{Δ , 1} ⇒ LOS link \\ < {I}_{Δ , 1} ⇒ NLOS link\end{matrix}$$

If Iₘₐₓ≥I_{Δ,1}, the second device 2 considers the link between the first device 1 and the second device 2 to be a LOS link. In this case, the first device 1 may determine strong enough transmit resources that are not associated with the LOS path.

For this purpose, the first device 1 is provided with the thresholds RSRP_{min,1}, RSRP_{Δ,1} and RSRP_{Δ,2}. Such thresholds can be configured, e.g. by the first device 1 or a third device, or preconfigured within the second device 2.

Additionally, the second device 2 may be provided with a threshold I_{Δ2}, that can be configured, e.g. by the first device 1 or a third device, or preconfigured within the device, and representing a relative threshold on the LOS/NLOS indicator of the transmit resource with respect to the LOS/NLOS indicator of the transmit resource associated with the LOS path. This allows better identification of the transmit resources not associated with the LOS path.

Thus, for identifying 43 the set of the one or more transmit resources i, the second device 2 may further be configured, upon an availability of a LOS link between the first device 1 and the second device 2, to identify 434 the set of the one or more transmit resources i to be associated with an NLOS link between the first device 1 and the second device 2 upon one or more of: if the determined reception level RSRPᵢ of the signal of the one or more transmit resources i of the first device 1 falls within a range defined by a first upper bound RSRPₘₐₓ−RSRP_{Δ,2} and a first lower bound max(RSRPₘₐₓ−RSRP_{Δ,1}, RSRP_{min,1}) for the reception level RSRP; and if the determined LOS/NLOS indicator Iᵢ for the signal of the one or more transmit resources i of the first device 1 is equal to or below a first upper bound Iₘₐₓ−I_{Δ,2} for the LOS/NLOS indicator I:

$$LOS link available :$$

$${RSRP}_{max} - {RSRP}_{Δ , 2} \geq {RSRP}_{i} \geq max ( {RSRP}_{max} - {RSRP}_{Δ , 1} , {RSRP}_{min , 1} )$$

$${I}_{max} - {I}_{Δ , 2} \geq {I}_{i}$$

The lower threshold serves to exclude transmit resources which result in reception levels that are too weak. The lower (fixed) threshold RSRP_{min,1} serves to filter out noise, i.e., a measurement of a transmit resource without any reflected signal. The other part of the lower threshold RSRPₘₐₓ−RSRP_{Δ,1} serves to remove transmit resources having reception levels that are too weak with respect to the strongest LOS path that is received with RSRPₘₐₓ, i.e., to exclude transmit resources which are associated with a too weak NLOS link relative to the strongest path. Considering a relative threshold with respect to the strongest path allows for a threshold independent of the distance between the first and the second device. For a shorter distance between the first and second devices, the path loss of the signal from the first device to the second device is smaller compared to a larger distance and thus, the lower threshold should be set higher.

The upper threshold for identifying the transmit resources is also based on a relative threshold with respect to the strongest LOS path. Considering a relative threshold with respect to the strongest path allows for a threshold independent of the distance between the first and second devices.

If Iₘₐₓ<I_{Δ,1}, the first device 1 considers the link between the first device 1 and the second device 2 to be an NLOS link. In this case, the first device 1 determines the transmit resources which result in reception levels that are sufficiently strong. For this purpose, the first device 1 may be provided with the thresholds RSRP_{Δ,3} and RSRP_{min,2}, that can be configured, e.g. by the first device 1 or a third device, or preconfigured within the device.

Hence, for identifying 43 the set of the one or more transmit resources i, the second device 2 may further be configured, upon a non-availability of a LOS link between the first device 1 and the second device 2, to identify 435 the set of the one or more transmit resources i to be associated with an NLOS link between the first device 1 and the second device 2 if the determined reception level RSRPᵢ of the signal of the one or more transmit resources i of the first device 1 is equal to or above a second lower bound max(RSRPₘₐₓ−RSRP_{Δ,3}, RSRP_{min,2}) for the reception level RSRP:

$$LOS link not available :$$

$${RSRP}_{i} \geq max ( {RSRP}_{max} - {RSRP}_{Δ , 3} , {RSRP}_{min , 2} )$$

The lower threshold excludes transmit resources which result in reception levels that are too weak. The lower (fixed) threshold RSRP_{min,2} serves to filter out noise, i.e., a measurement of a transmit resource without any reflected signal in case of a NLOS link. The other part of the lower threshold RSRPₘₐₓ−RSRP_{Δ,3} serves to remove transmit resources which result in reception levels that are too weak with respect to the strongest NLOS link that is received with RSRPₘₐₓ, i.e., to exclude transmit resources which are associated with a too weak NLOS link/reflection relative to the strongest reception level. Considering a relative threshold with respect to the strongest path allows for a threshold independent of the distance between the first and the second devices. This allows for identifying transmit resources with a strong enough RSRP.

Another implementation considers obstructed LOS links. An obstructed LOS link corresponds to a LOS link between the first device 1 and the second device 2 that is obstructed. In such a case, the transmit resources associated with RSRPₘₐₓ and Iₘₐₓ may differ. Thus, to identify whether a LOS link is obstructed, the second device 2 checks whether the transmit resource associated with the largest RSRP, i.e., RSRPₘₐₓ, corresponds to the transmit resource associated with the largest LOS/NLOS indicator, i.e., Iₘₐₓ. If not, then the second device 2 is supposed to identify the transmit resources with different thresholds as compared to the case when the LOS is not obstructed.

For this purpose, the second device may be provided with thresholds RSRP_{min,3}, RSRP_{Δ,4}. These thresholds can be configured, e.g. by the first device or a third device, or preconfigured within the device.

Additionally, the second device 2 may be provided with a threshold I_{Δ,3}, that can be configured, e.g. by the first device 1 or a third device, or preconfigured within the device, that represents a relative threshold on the LOS/NLOS indicator of the transmit resource with respect to the LOS/NLOS indicator of the transmit resource associated with the LOS path. This allows for better identification of the transmit resources not associated with the LOS path.

For identifying 43 the set of the one or more transmit resources i, the second device 2 may further be configured, upon an availability of a LOS link between the first device 1 and the second device 2 and if the largest reception level RSRPₘₐₓ and the largest LOS/NLOS indicator Iₘₐₓ relate to different transmit resources of the first device 1, to identify 436 the set of the one or more transmit resources i to be associated with an NLOS link between the first device 1 and the second device 2 upon one or more of: if the determined reception level RSRPᵢ of the signal of the one or more transmit resources i of the first device 1 is equal to or above a third lower bound max(RSRPₘₐₓ−RSRP_{Δ,4}, RSRP_{min,3}) for the reception level RSRP; and if the determined LOS/NLOS indicator Iᵢ for the signal of the one or more transmit resources i of the first device 1 is equal to or below a third upper bound Iₘₐₓ−I_{Δ,3} for the LOS/NLOS indicator I.

$$LOS link available and obstructed :$$

$${RSRP}_{i} \geq max ( {RSRP}_{max} - {RSRP}_{Δ , 4} , {RSRP}_{min , 3} )$$

$${I}_{max} - {I}_{Δ , 3} \geq {I}_{i}$$

The use of these thresholds provides for a better identification of the transmit resources which can be associated with a reflection from a passive object.

For sending 44 the measurement report, which has previously been explained in more detail, the second device 2 may further be configured to select 441 up to a configured maximum number M of the identified set of the one or more transmit resources i of the first device 1 being associated with a respective NLOS link between the first device 1 and the second device 2, in accordance with the configuration, which has also previously been explained in more detail.

The present disclosure has been described in conjunction with various implementations as examples. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation. A computer program may be stored/distributed on a suitable non-transitory computer-readable medium, such as an optical storage medium or a solid-state medium supplied together with or as part of other hardware, but may also be distributed in other forms, such as via the Internet or other wired or wireless telecommunication systems.

1. A first device for performing wireless sensing, comprising:
a computer including a computer program stored in a non-transitory computer-readable medium that when executed by the computer causes the computer to
send, to one or more second devices that are in communication with the first device, a configuration for identifying a set of transmit resources, of the first device, and that are associated with a non-line-of-sight (NLOS) link between the first device and the one or more second devices;
send a signal via one or more transmit resources of the set of transmit resources; and
receive, from the one or more of the second devices, respective measurement reports for the one or more of transmit resources of the first device (1).

2. The first device of claim 1, wherein the configuration comprises a lower bound (I_{Δ,1}) for a LOS link.

3. The first device of claim 1, wherein the configuration comprises an offset (RSRP_{Δ,3}) of a first lower bound for a reception level (RSRP) of a respective second device, of the one or more second devices, for the NLOS link between the first device and the respective second device relative to a largest reception level (RSRPₘₐₓ).

4. The first device of claim 1, wherein the configuration comprises a lower bound (RSRP_{min,2}) for a second lower bound for the reception level (RSRP) of the respective second device of the one or more second devices.

5. The first device of claim 3, wherein the configuration comprises an offset (RSRP_{Δ,1}) of a second lower bound for the reception level (RSRP) of the respective second device for the NLOS link between the first device and the respective second device relative to a largest reception level (RSRPₘₐₓ).

6. A first device for performing wireless sensing, comprising:
a computer including a computer program stored in a non-transitory computer-readable medium that when executed by the computer causes the computer to
receive, from a second device that is in communication with the first device, a configuration for identifying a set of transmit resources, of the second device, and that are associated with a non-line-of-sight (NLOS) link between the first device and the second device;
receive a signal of one or more transmit resources, of the set of transmit resources, of the second device;
identify the one or more transmit resources i of the second device that are associated with the NLOS link, in accordance with the configuration; and
send, to the second device, a measurement report being indicative of the one or more transmit resources i of the second device.

7. The first device of claim 6, wherein the computer program, when executed by the computer, further causes the computer to determine one or more reception levels (RSRPᵢ) of the one or more transmit resources.

8. The first device of claim 7, wherein the computer program, when executed by the computer, further causes the computer to identify the one or more transmit resources i by determining a largest reception level (RSRPₘₐₓ) among the one or more reception levels (RSRPᵢ).

9. The first device of claim 6, wherein the computer program, when executed by the computer, further causes the computer to identify the one or more transmit resources i by determining an LOS/NLOS indicator (Iᵢ) for the signal of the one or more transmit resources i.

10. The first device of claim 9, wherein the computer program, when executed by the computer, further causes the computer to identify the one or more transmit resources i by determining an availability of a LOS link between the first device and the second device based on one or more of:
a determined reception level (RSRPᵢ) of the signal of the one or more transmit resources i of the second device;
the determined LOS/NLOS indicator (Iᵢ) for the signal of the one or more transmit resources i of the second device; or
the first device has access to a LOS/NLOS indicator associated with the first device and the second device.

11. The first device of claim 10, wherein the computer program, when executed by the computer, further causes the computer to determine the availability of the LOS link by
determining a largest LOS/NLOS indicator (Iₘₐₓ) among the LOS/NLOS indicators (Iᵢ) for the signal; and
determining the availability of the LOS link when the largest LOS/NLOS indicator (Iₘₐₓ) is equal to or above a lower bound (I_{Δ,1}).

12. The first device of claim 11, wherein the computer program, when executed by the computer, further causes the computer to identify the one or more transmit resources i, when a LOS link between the first device and the second device is available, by identifying one or more transmit resources i to be associated with an NLOS link between the first device and the second device based on one or more of:
a determined reception level (RSRPᵢ) of the signal of the one or more transmit resources i falls within a range defined by a first upper bound and a first lower bound for the reception level (RSRP); or
the determined LOS/NLOS indicator (Iᵢ) for the signal of the one or more transmit resources i is equal to or below a first upper bound for the LOS/NLOS indicator (Iᵢ).

13. The first device of claim 11, wherein the computer program, when executed by the computer, further causes the computer to identify the one or more transmit resources i by
identifying one or more transmit resources i to be associated with an NLOS link between the first device and the second device when a determined reception level (RSRPᵢ) of the signal of the one or more transmit resources i is equal to or above a second lower bound for the reception level (RSRP), and when a LOS link between the first device and the second device is not available.

14. The first device of claim 11, wherein the computer program, when executed by the computer, further causes the computer to identify the one or more transmit resources i by
identifying the one or more transmit resources i to be associated with an NLOS link, when a LOS link between the first device and the second device is available, and when a largest reception level (RSRPₘₐₓ) and a largest LOS/NLOS indicator (Iₘₐₓ) relate to different transmit resources of the second device, based on one or more of:
the determined reception level (RSRPᵢ) of the signal of the one or more transmit resources i of the second device is equal to or above a third lower bound for the reception level (RSRP); or
a determined LOS/NLOS indicator (Iᵢ) for the signal of the one or more transmit resources i of the second device is equal to or below a third upper bound for the LOS/NLOS indicator (Iᵢ).

15. The first device of the claim 6, wherein the computer program, when executed by the computer, further causes the computer to send the measurement report by selecting up to a configured maximum number (M) of the identified one or more transmit resources i of the second device that are associated with a NLOS link between the first device and the second device, in accordance with the configuration.

16. A method for wireless sensing, comprising:
receiving by a first device, from a second device in communication with the first device, a configuration for identifying a set of transmit resources, of the second device, and that are associated with a non-line-of-sight (NLOS) link between the first device and the second device;
receiving a signal of one or more transmit resources, of the set of transmit resources, of the second device;
identifying the one or more transmit resources i of the second device that are associated with the NLOS link, in accordance with the configuration; and
sending, to the second device, a measurement report being indicative of the one or more transmit resources i of the second device.

17. The method of claim 16, further comprising determining one or more reception levels (RSRPᵢ) of the one or more transmit resources i.

18. The method of claim 17, further comprising identifying the one or more transmit resources i by determining a largest reception level (RSRPₘₐₓ) among the one or more reception levels (RSRPᵢ).

19. The method of claim 17, further comprising identifying the one or more transmit resources i by determining an LOS/NLOS indicator (Iᵢ) for the signal of the one or more transmit resources i of the second device.

20. The method of claim 19, further comprising identifying the one or more transmit resources i by determining that a LOS link between the first device and the second device is available based on one or more of:
a determined reception level (RSRPᵢ) of the signal of the one or more transmit resources i of the second device;
the determined LOS/NLOS indicator (Iᵢ) for the signal of the one or more transmit resources i of the second device; or
the first device has access to a LOS/NLOS indicator associated with the first device and the second device.
